(19) United States
(12) Patent Application Publication
(10) Pub. No.: US 2025/0109581 A1
(43) Pub. Date: Apr. 3, 2025

(54) FLUSH TOILET

(71) Applicant: TOTO LTD., Kitakyushu-shi (JP)

(72) Inventors: Shu KASHIRAJIMA, Kitakyushu-shi (JP); Makoto BEKKI, Kitakyushu-shi (JP)

(73) Assignee: TOTO LTD., Kitakyushu-shi (JP)

(21) Appl. No.: 18/823,010

(22) Filed: Sep. 3, 2024

(30) Foreign Application Priority Data
Sep. 29, 2023 (JP) 2023-170269

(51) Int. Cl. E03D 5/10; E03D 5/01; E03D 11/08

(52) U.S. Cl. CPC E03D 5/105; E03D 5/01; E03D 11/08; E03D 2201/40

(57) ABSTRACT

A flush toilet comprises a bowl including a waste receiving surface and a rim, a discharge trap conduit, a spouting portion provided in the bowl to spout the flush water, a flush water supply device configured to supply the flush water to the spouting portion, a waste information acquisition device configured to acquire an information regarding the waste excreted in the bowl, and a controller configured to determine a waste state by using the information regarding the waste and control the flush water supply device based on determination of the waste state. The controller controls the flush water supply device based on the determination of the waste state of the waste for each flush to the toilet so as to change a spout mode of the flush water spouted from the spouting portion

### TECHNICAL FIELD

The present invention relates to a flush toilet, and in particularly to a flush toilet that flushes the toilet and discharges waste by using flush water.

### BACKGROUND ART

A user selects on his or her own a large flush, a small flush or a so-called eco-small flush (that flushes a toilet with a smaller amount of water than that of the small flush) to flush the toilet. A flush water amount used in each flush is set to an amount that allows discharge of various waste states (such as an amount of the waste). This flush water amount is always constant and cannot be changed in accordance with the waste state for each toilet flush. Therefore, when the amount of the waste is less than the predetermined amount, for example, the waste can be discharged, however more water than the necessary amount of the water may be used.

Conventionally, as described in Patent Document 1, there is known a flush toilet that changes an instantaneous flow rate of the rim spouting water for subsequent flushes to the toilet based on the presence or absence of the waste in the bowl after flushing the toilet. In such a flush toilet, the instantaneous flow rate of the rim spouting water is changed for subsequent flushes to the toilet so that the waste does not remain in the bowl.

Further, as described in Patent Document 2, there is known a flush toilet that, for a small flush, changes the flush water amount depending on whether toilet paper is used. In such a flush toilet, the flush water amount can be reduced when toilet paper is not used.

### CITATION LIST

### Patent Literature

Patent Document 1: JP 2017-193838 A

Patent Document 2: JP 2019-526003 A

### SUMMARY OF INVENTION

### Technical Problem

However, the flush toilet described in Patent Document 1 changes the instantaneous flow rate of rim spouting water for subsequent flushes to the toilet, but cannot change the instantaneous flow rate based on the waste state for each flush to the toilet. Therefore, when the amount of waste is less than the predetermined amount, for example, there is a problem in that more water than necessary is used.

Further, the flush toilet described in Patent Document 2 changes the flush water amount for a small flush depending on whether toilet paper is used, but cannot change the flush water amount in accordance with the waste state for a large flush. Therefore, when the amount of waste is less than the predetermined amount, for example, there is a problem in that more water than the necessary amount of the water is used.

The present invention has been made in order to solve the problems in the conventional art described above, and an object thereof is to provide a flush toilet capable of performing an optimal flush to the toilet based on a waste state for each flush to the toilet and achieving further water saving and improving waste discharge performance.

### Solution to Problem

In order to achieve the object described above, the present invention provides a flush toilet that flushes the toilet and discharges waste by using flush water, the flush toilet comprising a bowl including a waste receiving surface configured to receive the waste and a rim formed above the waste receiving surface, a discharge trap conduit connected to a lower part of the bowl to discharge the waste, a spouting portion provided in the bowl to spout the flush water, a flush water supply device configured to supply the flush water to the spouting portion, a waste information acquisition device configured to acquire information regarding the waste excreted in the bowl, and a controller configured to determine a waste state by using the information regarding the waste and control the flush water supply device based on the determination of the waste state for each flush to the toilet so as to change a spout mode of the flush water spouted from the spouting portion.

According to the present invention configured as described above, since the controller determines a waste state by using the information regarding the waste and control the flush water supply device based on the determination of the waste state for each flush to the toilet so as to change a spout mode of the flush water spouted from the spouting portion, an optimal flush to the toilet based on a waste state for each flush to the toilet can be performed and a further water saving can be achieved and a waste discharge performance can be improved.

In the present invention, preferably, the flush water supply device is a pump, and the controller controls the pump so as to change the spout mode of the flush water spouted from the spouting portion.

In the present invention configured as described above, since the flush water supply device is a pump, and the controller controls the pump so as to change the spout mode of the flush water spouting from the spouting portion, the spout mode for each flush to the toilet can be easily changed.

Further, in the present invention, preferably, the controller changes a flow velocity or a spouting duration of the flush water spouted from the spouting portion so as to change the spout mode of the flush water spouting from the spouting portion.

In the present invention configured as described above, since the controller changes a flow velocity or a spouting duration of the flush water spouted from the spouting portion so as to change the spout mode of flush water spouted from the spouting portion, the spout mode can be easily changed.

In the present invention, preferably, the controller determines the waste state based on the information regarding the waste in the bowl and the waste in the pooled water in the bowl.

In the present invention configured as described above, since the controller determines the waste state based on the information regarding the waste in the bowl and the waste in the pooled water in the bowl, the waste state can be determined based on the information regarding the waste in the bowl, which has a large impact on a toilet flushing performance, and the information regarding the waste in the pooled water, which has a large impact on the waste discharge performance, and therefore an optimal toilet flush based on the waste state can be performed.

Further, in the present invention, preferably, the spouting portion includes a rim spouting portion provided in the rim to spout the flush water along the rim and a jet spouting portion provided at a bottom of the bowl to spout the flush water toward an inlet of the discharge trap conduit, and the controller changes a spout mode of the flush water spouted from the rim spouting portion based on the waste state on the waste receiving surface of the bowl, and changes the spout mode of the flush water spouted from the jet spouting portion based on the waste state in the pooled water in the bowl.

In the present invention configured as described above, since the rim spouting portion provided in the rim to spout the flush water along the rim and the jet spouting portion provided at the bottom portion of the bowl to spout the flush water toward the inlet of the discharge trap conduit are provided, and the controller changes the spout mode of the flush water spouted from the rim spouting portion based on the waste state on the waste receiving surface of the bowl and changes the spout mode of the flush water spouted from the jet spouting portion based on the waste state in the pooled water in the bowl, the spout modes based on the waste state in each area can be respectively changed, and therefore an optimal toilet flush based on the waste state can be performed.

In the present invention, preferably, the controller determines the waste state based on a type of the waste and an amount of the waste, both of which are the information regarding the waste.

In the present invention configured as described above, since the controller determines the waste state based on the type of the waste and the amount of the waste, the waste state can be determined with high accuracy.

Further, in the present invention, preferably, the controller determines the waste state based on a location or a distribution of the waste.

In the present invention configured as described above, since the controller determines the waste state based on the location or the distribution of the waste, the waste state can be determined with higher accuracy.

### Advantageous Effects of Invention

According to the flush toilet of the present invention, an optimal toilet flush based on a waste state for each flush to the toilet can be performed, and further water saving can be achieved and the waste discharge performance is improved.

### BRIEF DESCRIPTION OF DRAWINGS

FIG. 1 is a perspective view of a flush toilet according to an embodiment of the present invention.

FIG. 2 is an overall configuration diagram of the flush toilet according to the embodiment of the present invention.

FIG. 3 is a block diagram illustrating a configuration regarding a controller of the flush toilet according to the embodiment of the present invention.

FIG. 4A is a diagram illustrating a pattern A of a waste state, (FIG. 4A-1) being a cross-sectional view of a bowl of the flush toilet according to the embodiment of the present invention as viewed from the side, and (FIG. 4A-2) being a plan view of the bowl of the flush toilet according to the embodiment of the present invention as viewed from above.

FIG. 4B is a diagram illustrating a pattern B of a waste state, (FIG. 4B-1) being a cross-sectional view of the bowl of the flush toilet according to the embodiment of the present invention as viewed from the side, and (FIG. 4B-2) being a plan view of the bowl of the flush toilet according to the embodiment of the present invention as viewed from above.

FIG. 4C is a diagram illustrating a pattern C of a waste state, (FIG. 4C-1) being a cross-sectional view of the bowl of the flush toilet according to the embodiment of the present invention as viewed from the side, and (FIG. 4C-2) being a plan view of the bowl of the flush toilet according to the embodiment of the present invention as viewed from above.

FIG. 4D is a diagram illustrating a pattern D of a waste state, (FIG. 4D-1) being a cross-sectional view of the bowl of the flush toilet according to the embodiment of the present invention as viewed from the side, and (FIG. 4D-2) being a plan view of the bowl of the flush toilet according to the embodiment of the present invention as viewed from above.

FIG. 5 is a flowchart illustrating a control of a flush to the toilet in the flush toilet according to the embodiment of the present invention.

FIG. 6A is a time chart illustrating a flush pattern A of jet spouting of the flush toilet according to the embodiment of the present invention.

FIG. 6B is a time chart illustrating a flush pattern B of jet spouting of the flush toilet according to the embodiment of the present invention.

FIG. 6C is a time chart illustrating a flush pattern C of jet spouting of the flush toilet according to the embodiment of the present invention.

FIG. 6D is a time chart illustrating a flush pattern D of jet spouting of the flush toilet according to the embodiment of the present invention.

### DESCRIPTION OF EMBODIMENTS

A flush toilet according to an embodiment of the present invention will be described below with reference to the accompanying drawings.

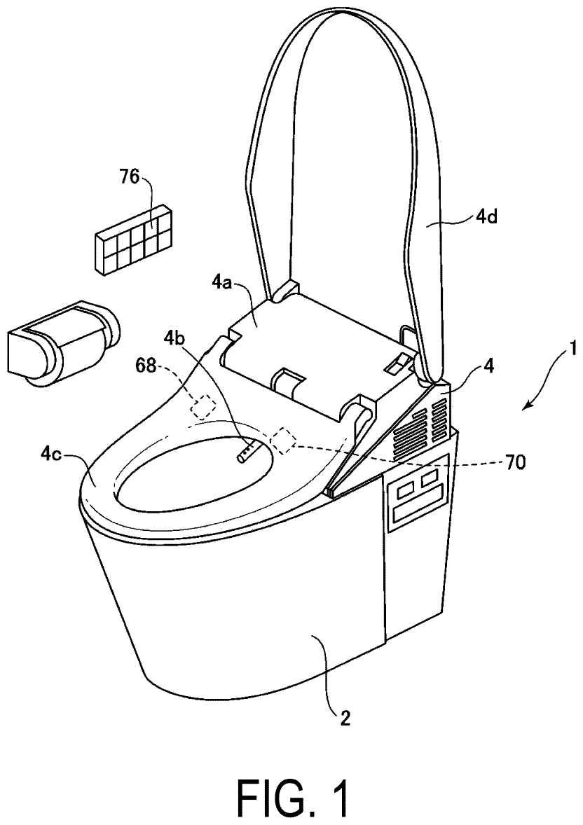

First, an overall configuration of the flush toilet according to the embodiment of the present invention will be described with reference to FIGS. 1 to 3.

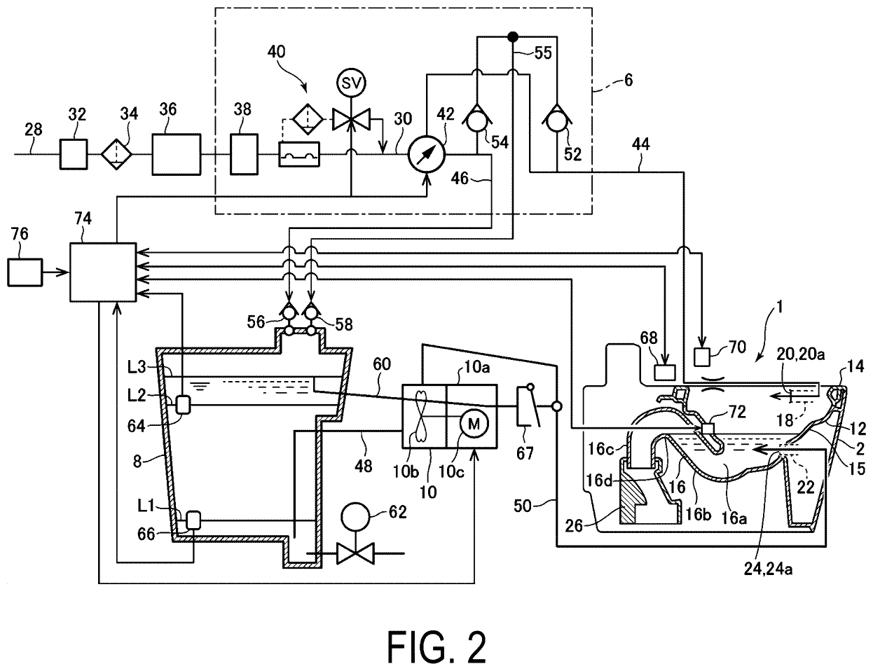

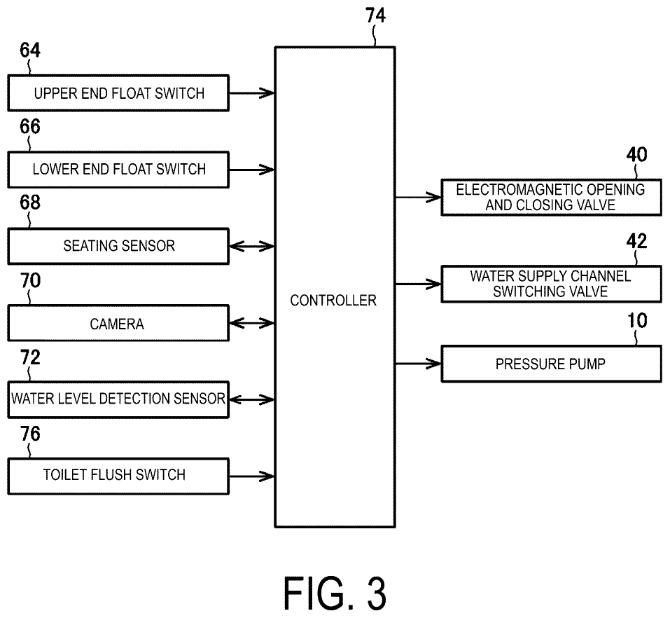

FIG. 1 is a perspective view of the flush toilet according to the embodiment of the present invention, FIG. 2 is an overall configuration diagram of the flush toilet according to the embodiment of the present invention, and FIG. 3 is a block diagram illustrating a configuration regarding a controller of the flush toilet according to the embodiment of the present invention.

As illustrated in FIGS. 1 and 2, a flush toilet 1 according to the embodiment of the present invention is a siphon jet toilet and includes a toilet main body 2 made of a ceramic, a warm water washing toilet seat 4 disposed on an upper surface of the toilet main body 2, a valve unit 6 that supplies flush water to the toilet main body 2, a water storage tank 8 that stores flush water, and a pressure pump 10 that supplies the flush water stored in the water storage tank 8 to the toilet main body 2.

Note that, in the present embodiment, a case in which the flush toilet is a siphon jet toilet will be described, but the flush toilet is not limited thereto and may be a siphon toilet or a washdown toilet.

A bowl 15 and a discharge trap conduit 16 are formed in the toilet main body 2. The bowl 15 includes a waste receiving surface 12 having a bowl shape that receives the waste, and a rim 14 formed above the waste receiving surface 12. The discharge trap conduit 16 is connected to a bottom portion below the bowl 15 so as to discharge waste. A rim conduit 18 is formed inside the rim 14, and a rim spout port 20a for rim spouting is formed in a rim spouting portion 20 located at a downstream end of this rim conduit 18. The rim spout port 20a is formed in a front right area of the bowl 15 when the flush toilet 1 is viewed from the front, and spouts flush water rearward to form a circulating flow along an inner peripheral surface of the rim 14.

Further, a jet conduit 22 is formed at a lower part of the toilet main body 2, and a jet spout port 24a for jet spouting is formed in a jet spouting portion 24 located at a downstream end of the jet conduit 22. The jet spout port 24a is located in a bottom portion of the bowl 15, disposed substantially horizontally toward an inlet portion 16a of the discharge trap conduit 16, and configured to spout the flush water toward the inlet portion 16a of the discharge trap conduit 16.

The discharge trap conduit 16 is composed of the inlet portion 16a, a trap ascending pipe 16b ascending from the inlet portion 16a, and a trap descending pipe 16c descending from the trap ascending pipe 16b. Further, a top portion 16d is formed between the trap ascending pipe 16b and the trap descending pipe 16c. A discharge socket 26 is connected to a lower end of the trap descending pipe 16c of the discharge trap conduit 16.

As illustrated in FIG. 1, the warm water washing toilet seat 4 includes a main portion 4a, a washing nozzle 4b provided so as to be advanceable and retractable from the main portion 4a, a toilet seat 4c rotatably attached to the main portion 4a, and a toilet lid 4d rotatably attached to the main portion 4a so as to cover the toilet seat 4c.

As illustrated in FIG. 2, the valve unit 6 includes a main water supply channel 30 to which the flush water is supplied from a water line 28 serving as a water supply source, and the main water supply channel 30 is provided with a constant flow valve 38, an electromagnetic opening and closing valve 40 of a diaphragm type, and a water supply channel switching valve 42 from an upstream side. Furthermore, the main water supply channel 30, on an upstream side of the valve unit 6, is provided with a stop cock 32, a strainer 34, and a metal branch fitting 36 from the upstream side. The main water supply channel 30 includes a water supply hose connected to the water line 28 outside the toilet.

Further, a rim-side water supply channel 44 for supplying flush water to the rim spout port 20a and a tank-side water supply channel 46 for supplying the flush water to the water storage tank 8 are connected to a downstream side of the water supply channel switching valve 42. The rim conduit 18 is connected to a downstream end of the rim-side water supply channel 44, and the flush water is supplied to the rim spout port 20a by the water supply pressure of the water supply.

The constant flow valve 38 is a valve for restricting the flush water flowing in through the stop cock 32, the strainer 34, and the metal branch fitting 36 to a predetermined flow rate or less. Further, the flush water passing through the constant flow valve 38 flows into the electromagnetic opening and closing valve 40, and the flush water passing through the electromagnetic opening and closing valve 40 is supplied from the rim-side water supply channel 44 that is on the rim side to the rim spout port 20a, or from the tank-side water supply channel 46 that is on the tank side to the water storage tank 8, by the water supply channel switching valve 42.

The water supply channel switching valve 42 (flush water supply device) is a switching valve that can supply flush water to both the rim-side water supply channel 44 and the tank-side water supply channel 46 at the same timing, and the switching valve can change ratios of the water supply amounts and the flow rates to the rim side and tank side as desired. The water supply channel switching valve 42 includes a rotor (not illustrated) for changing the ratios of the water supply amounts and the flow rates to the rim side and the tank side. This rotor is driven by a motor (not illustrated) to a desired position.

Note that, in the present embodiment, a water supply channel switching valve is used as the flush water supply device, but an electromagnetic opening and closing valve that can change a flow channel cross-sectional area may be used instead of the water supply channel switching valve.

The pump-side water supply channel 48 is connected to a lower portion of the water storage tank 8, and the pressure pump 10 including a pump chamber is connected to a downstream end of this pump-side water supply channel 48. Furthermore, the pressure pump 10 and the jet conduit 22 are connected by a jet-side water supply channel 50, and the pressure pump 10 is configured to pressurize flush water stored in the water storage tank 8 to supply the flush water to the jet spout port 24a.

The pressure pump 10 (flush water supply device) is configured to pressurize the flush water stored in the water storage tank 8, causing the flush water to be spouted from the jet spout port 24a at a predetermined flow rate. The pressure pump 10 is connected to the pump-side water supply channel 48 on an upstream side thereof, and is connected to the jet-side water supply channel 50 on a downstream side thereof. The pressure pump 10 includes a casing 10a, an impeller 10b that is a bladed wheel provided in the casing so as to be rotatable in both directions of a normal rotation direction and a reverse rotation direction, and a motor 10c that rotates the impeller 10b, and is a centrifugal pump that pumps the flush water in the water storage tank 8 by utilizing a centrifugal force generated by the rotation of the impeller 10b.

Note that, in the embodiment, a pressure pump is used as the flush water supply device, but a pressure storage booster that accumulates the energy of water, an air compressor that uses compressed air as power, or the like may be used instead of the pressure pump.

The rim-side water supply channel 44 is provided with a vacuum breaker 52 that is a check valve, and the tank-side water supply channel 46 is also provided with a vacuum breaker 54 that is a check valve. These vacuum breakers prevent backflow from the rim spout port 20a and the water storage tank 8. Furthermore, the flush water overflowing from an atmosphere opening portion of the vacuum breaker 52 of the rim-side water supply channel 44 flows into the water storage tank 8 through a return pipe 55.

The water storage tank 8 is a closed-type water storage tank. A ball-type check valve 56 is provided at a connection portion between the tank-side water supply channel 46 and the water storage tank 8, and a ball-type check valve 58 is also provided at a connection portion between the return pipe 55 and the water storage tank 8. The ball-type check valves prevent the flush water from flowing backward even in a case in which the water storage tank 8 is filled with the water beyond the position of an upper end of an overflow channel.

A water drain cock 62 is provided at a bottom portion of the water storage tank 8. Thes water drain cock 62 is disposed below the pressure pump 10, and the flush water in the water storage tank 8 and in the pressure pump 10 can be discharged by opening the water drain cock 62 during maintenance.

An upper end float switch 64 and a lower end float switch 66 are disposed inside the water storage tank 8. The upper end float switch 64 is switched to an on state when the water level in the water storage tank 8 reaches a predetermined position L2 slightly lower than a highest water level L3 during normal use, and a controller 74 detects the on-state and closes the electromagnetic opening and closing valve 40. The lower end float switch 66 is switched to an on state when the water level in the water storage tank 8 lowers to a lowest water level L1 during normal use, and the controller 74 detects the on-state and stops the pressure pump 10.

Further, an overflow channel 60 for discharging overflowing flush water is provided inside the water storage tank 8, an upper end of the overflow channel 60 opens into the water storage tank 8, and a lower end thereof is connected to the jet-side water supply channel 50. A flapper valve 67, which is a check valve, is attached to the overflow channel 60, so that backflow from the jet spout port 24a can be prevented.

As illustrated in FIGS. 1 and 2, the flush toilet 1 includes a seating sensor 68 for detecting a seating action by a user, a camera 70 for detecting a waste state after excretion by the user, a water level detection sensor 72 for detecting a water level change of pooled water W, and the controller 74 that controls the electromagnetic opening and closing valve 40, the water supply channel switching valve 42, and the pressure pump 10 based on an information acquired from the camera 70 and the water level detection sensor 72.

The seating sensor 68 is provided in a rear left area on a back surface of the toilet seat 4c of the warm water washing toilet seat 4. The seating sensor 68 is a load sensor that detects a load of the user. The seating sensor 68 can detect a change in load when the user is seated on the toilet seat 4c, and detect a start and an end of excretion by the user.

Note that, although a load sensor is used as the seating sensor 68 in the embodiment, an infrared distance measurement sensor or the like may be used instead of the load sensor.

The camera 70 (waste information acquisition device) is provided in a rear area on the back surface of the toilet seat 4c of the warm water washing toilet seat 4. When the user is seated on the toilet seat 4c, the camera 70 can capture an image of the bowl 15 and a pooled water surface from above, and acquire a captured image (information regarding waste) of the bowl 15 and the pooled water surface viewed from above. The camera 70 includes a light-emitting diode (LED; not illustrated) and can capture an image in a state in which the bowl 15 is illuminated.

Note that, in the embodiment, the camera 70 is provided on the back surface of the toilet seat 4c, but may be provided at the main portion 4a or the toilet lid 4d of the warm water washing toilet seat 4. Further, although a camera that captures an image of the bowl 15 and the pooled water surface is used as the waste information acquisition device in the embodiment, a line sensor camera that captures an image of the waste during falling of the waste with a line or a video camera may be used to acquire information regarding the waste during falling of the waste instead of the camera. Thus, as the information regarding the waste, information regarding the waste present in the bowl 15 and on the pooled water surface may be acquired, information regarding the waste during falling of the waste may be acquired, or such information may be selected and acquired as desired.

The water level detection sensor 72 (waste information acquisition device) is an ultrasonic distance measurement sensor that measures a height of the pooled water surface using ultrasonic waves. The water level detection sensor 72 is disposed on a back surface of the bowl 15 at substantially the same height as that of the highest water level of the pooled water W. The water level detection sensor 72 can acquire numerical data of the pooled water level (information regarding the waste). Accordingly, by measuring the height of the pooled water surface, information regarding the waste present on the pooled water surface can be acquired.

Note that, although provided on the back surface of the bowl 15 in the embodiment, the water level detection sensor 72 may be provided on the back surface of the toilet seat 4c or a back surface of the discharge trap conduit 16. Further, although an ultrasonic distance measurement sensor is used as the water level detection sensor in the embodiment, a radio wave sensor, a capacitance sensor, a pressure sensor, or the like may be used instead of the ultrasonic distance measurement sensor. Further, the camera 70 may be used as the water level detection sensor, and the height of the pooled water surface may be measured based on the image captured from the camera 70.

As illustrated in FIG. 3, the controller 74 is electrically connected to the upper end float switch 64, the lower end float switch 66, the seating sensor 68, the camera 70, the water level detection sensor 72, a toilet flush switch 76, the electromagnetic opening and closing valve 40, the water supply channel switching valve 42, and the pressure pump 10. When the toilet flush switch 76 is pressed, the controller 74 sequentially operates the electromagnetic opening and closing valve 40, the water supply channel switching valve 42, and the pressure pump 10, thereby first spouting flush water from the rim spout port 20a, then spouting flush water from the jet spout port 24a while continuing rim spouting, and finally spouting flush water from the rim spout port 20a.

Note that, in the embodiment, the controller 74 is connected to various devices by wire, but the controller 74 may be wirelessly connected to various devices.

The controller 74 is configured to determine the waste state based on the captured image of the bowl 15, the pooled water surface, and the waste during falling of the waste from the camera 70 and the numerical data of the pooled water level from the water level detection sensor 72, and control the pressure pump 10 based on this determination. Further, the controller 74 is configured to control the pressure pump 10 based on the determination of the waste state for each flush to the toilet so as to change a spout mode of flush water spouted from the jet spout port 24a.

Further, the controller 74 is configured to control the water supply channel switching valve 42 based on the determination of the waste state by the captured image of the bowl 15, the pooled water surface, and the waste during falling of the waste from the camera 70 and the numerical data of the pooled water level from the water level detection sensor 72. Further, the controller 74 is configured to control the water supply channel switching valve 42 based on the determination of the waste state for each flush to the toilet so as to change a spout mode of the flush water spouted from the rim spout port 20a.

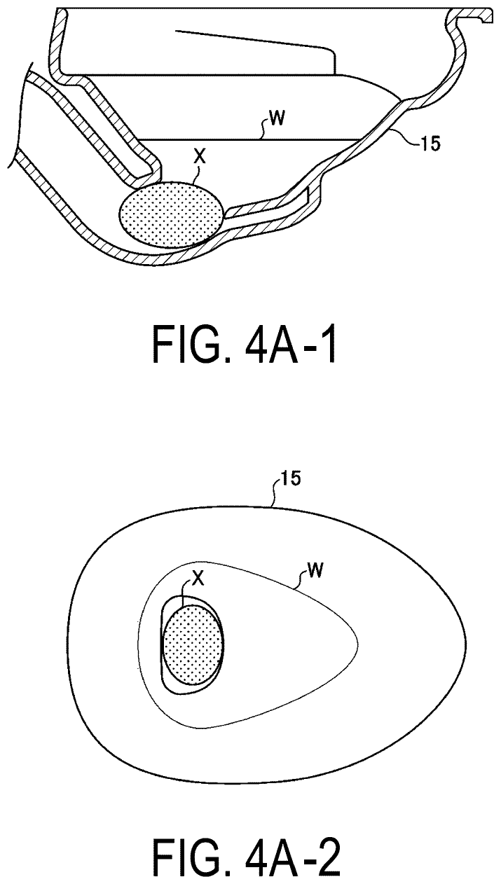

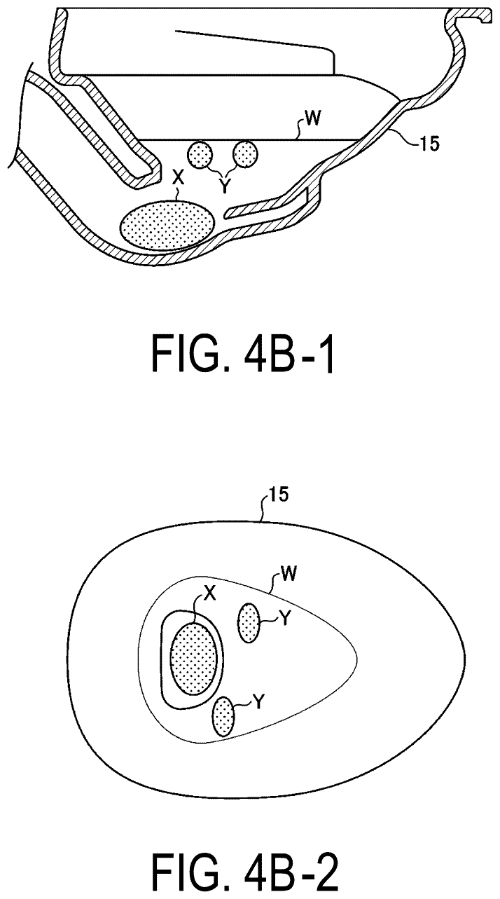

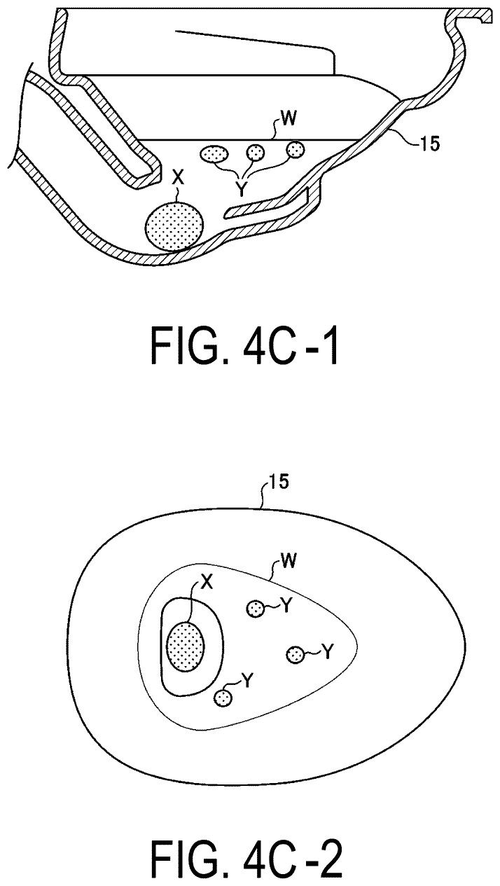

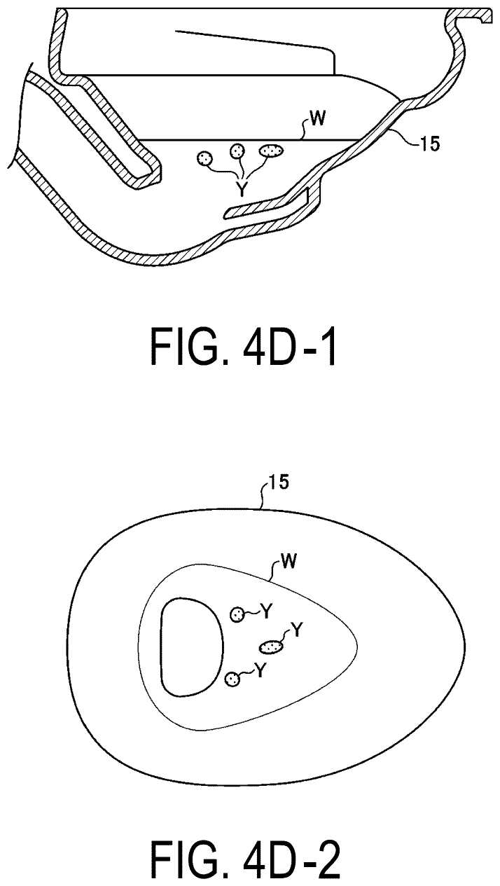

Next, the concept of toilet flushing by the flush toilet 1 according to the embodiment of the present invention will be described. In each of FIGS. 4A to 4D that are diagrams illustrating patterns A to D of the waste state, FIG. 4A-1, FIG. 4B-1, FIG. 4C-1, and FIG. 4D-1 are a cross-sectional view of the bowl of the flush toilet according to the embodiment of the present invention as viewed from the side, and FIG. 4A-2, FIG. 4B-2, FIG. 4C-2, and FIG. 4D-2 are a plan view of the bowl of the flush toilet according to the embodiment of the present invention as viewed from above.

The waste state according to the embodiment of the present invention is classified into the following patterns A to D of a waste state based on a type of the waste and an amount of the waste, for example. Here, the types of waste are set to the three types of “solid waste”, “floating waste”, and “mixed waste containing solid waste and floating waste (hereinafter referred to as mixed waste)”, and the amounts of waste, given “standard” as typical waste of a user, are set to the four levels of “large”, “standard”, “somewhat small”, and “small” with respect to the “standard”. “Solid waste” refers to lumpy waste that sinks in pooled water, “floating waste” refers to waste that floats on the pooled water surface, and “mixed waste” refers to waste that is a mixture of both solid waste and floating waste.

First, as illustrated in FIG. 4A, the pattern A of the waste state is a state in which the type of waste is “solid waste”, and the amount of waste is “large”. Solid waste X sinks in the pooled water and the amount of solid waste X is greater than the amount of standard waste. Accordingly, to sufficiently discharge the waste, desirably a toilet flush is performed after the flush water amount is increased to more than that of a normal large flush, improving a waste discharge performance.

As illustrated in FIG. 4B, the pattern B of the waste state is a state in which the type of waste is “mixed waste”, and the amount of waste is “standard”. The solid waste X sinks in the pooled water, and floating waste Y floats on the pooled water surface. The solid waste X and the floating waste Y are standard amounts that are average amounts of the waste of users. Accordingly, desirably a normal large flush is performed.

As illustrated in FIG. 4C, the pattern C of the waste state is a state in which the type of waste is “mixed waste”, and the amount of waste is “somewhat small”. The solid waste X sinks in the pooled water, and the floating waste Y floats on the pooled water surface. The amount of the solid waste X and the floating waste Y is somewhat smaller than the standard amount. Therefore, although the waste can be discharged by a normal large flush, when a normal large flush is performed, more water than necessary is used. Accordingly, in order to save water, desirably a toilet flush is performed after reducing the flush water amount to less than that of a normal large flush.

As illustrated in FIG. 4D, the pattern D of the waste state is a state in which the type of waste is “floating waste”, and the amount of waste is “small”. The floating waste Y floats on the pooled water surface. The amount of floating waste Y is less than the standard amount. Therefore, although the waste can be discharged by a normal large flush, when a normal large flush is performed, more water than necessary is used. Accordingly, in order to save water, desirably a toilet flush is performed after reducing the flush water amount to less than that of a normal large flush.

As described above, it can be understood that the desired flush water amount and the waste discharge performance differ depending on the waste state (type of waste and amount of waste, for example).

However, in the flush toilet in the conventional art, a normal large flush is uniformly performed, regardless of the waste state. Therefore, the inventors of the present invention found that further water saving and improvement in waste discharge performance can be achieved if an optimal toilet flush can be performed according to the waste state for each flush to the toilet.

According to the present invention, an optimal toilet flush according to the waste state for each flush to the toilet can be performed, and further water saving can be achieved and waste discharge performance can be improved.

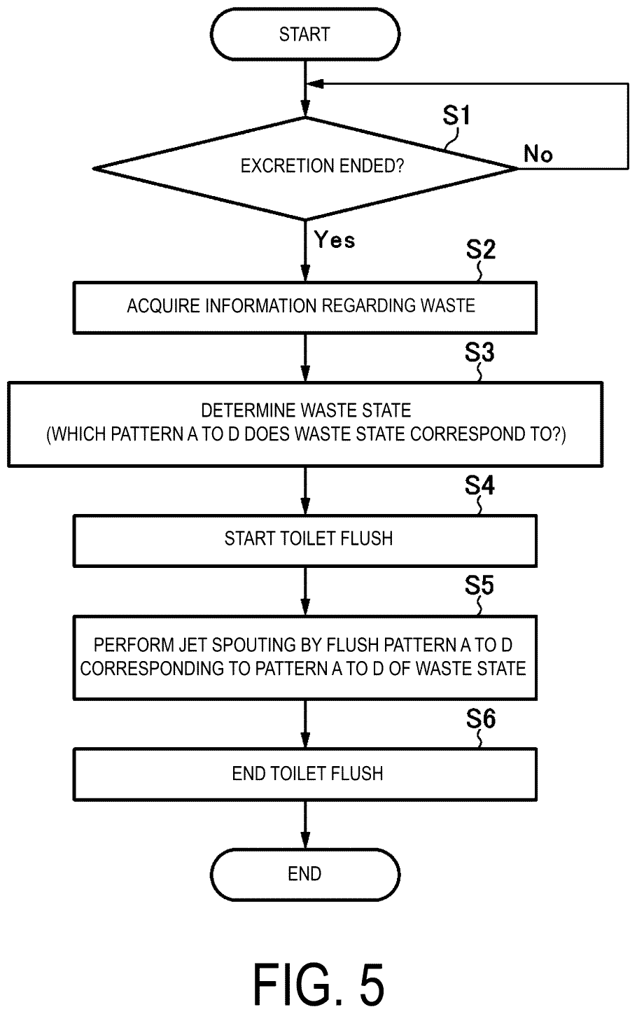

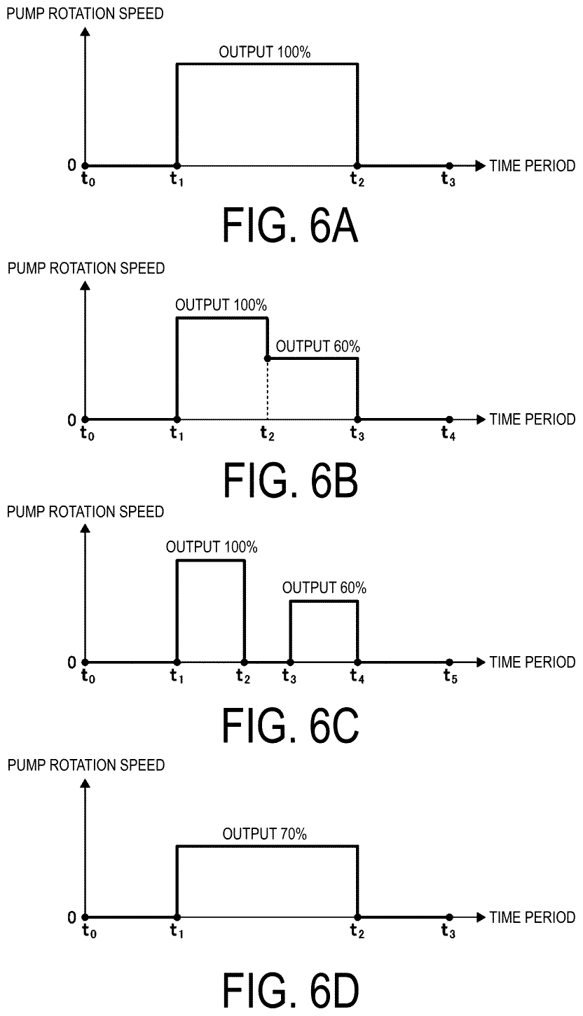

Next, the control of a flush to the toilet in the flush toilet 1 according to the embodiment of the present invention will be described in detail. FIG. 5 is a flowchart illustrating the control of a flush to the toilet in the flush toilet according to the embodiment of the present invention, and FIG. 6 illustrates time charts illustrating flush patterns A to D of the jet spouting of the flush toilet according to the embodiment of the present invention.

Note that, in FIG. 5, S indicates each step.

As illustrated in FIG. 5, after the user is seated on the toilet seat 4c, the process proceeds to S1 and whether excretion by the user has ended is determined. Specifically, when a change in the signal from the seating sensor 68 (change in a seating state) is detected, it is determined that excretion by the user has ended, and the process proceeds to S2 (S1: Yes). Further, when a change in the signal from the seating sensor is not detected, the controller 74 determines that excretion by the user has not ended (S1: No).

Next, in S2, an information regarding the excreted waste is acquired. The information regarding the waste is acquired by the camera 70 and the water level detection sensor 72 immediately after an excretion by the user (before the user uses toilet paper). The camera 70 captures an image of the bowl 15 from the above position of the bowl and acquires, as information regarding the waste, the captured image of the bowl 15 and the pooled water surface after excretion as viewed from above (refer to FIG. 4A-2, FIG. 4B-2, FIG. 4C-2, and FIG. 4D-2). Further, the water level detection sensor 72 acquires numerical data of the pooled water level after excretion as the information regarding the waste (for example, information regarding the amount of waste present on the pooled water surface).

Note that, in the embodiment, the captured image of the bowl and the pooled water surface and the numerical data of the pooled water level are acquired as the information regarding the waste. However, instead, a captured image of the inside of the discharge trap conduit, numerical data of the water pressure of the pooled water, or the like may be acquired. Further, in the embodiment, the information regarding waste is acquired immediately after excretion by the user (before user uses toilet paper), but may be acquired after the user uses toilet paper.

Next, in S3, the waste state is determined. Specifically, the controller 74 compares the captured image acquired in S2 described above with a reference image, and determines the corresponding pattern of the waste state among the patterns A to D described above. The reference image is an image obtained by capturing an image of the bowl with no waste from the above position of the bowl, and the reference image is stored in advance in the controller 74. In the comparison between the captured image and the reference image, a luminance, a hue, a saturation, a gradation, and the like of each image are converted into numerical values, and the corresponding pattern of the waste state among the patterns A to D is determined by comparing the numerical values of the images. Further, in the embodiment, the waste state is determined based on the type of waste and the amount of waste. Accordingly, since the waste state is determined based on the information regarding the waste in the bowl that greatly affects a flushing performance of the toilet, an optimal toilet flush regarding the waste state can be performed.

Note that, in the embodiment, the waste state is determined based on the type of waste and the amount of waste. However, the waste state may be determined based on position or the distribution of waste in addition to the type of waste and the amount of waste. Further, in the embodiment, an image of the bowl with no waste viewed from the above position of the bowl is used as the reference image. However, an image of the pattern B (refer to FIG. 4B-2) of a standard waste state may be used.

Further, the controller 74 compares the captured image of the pooled water surface and the numerical data of the pooled water level acquired in S2 with threshold values, and determines the corresponding pattern of the waste state among the patterns A to D described above. A threshold value is determined in advance for each of the patterns A to D of the waste state. Thus, since the waste state is determined based on the information regarding waste in the pooled water that greatly affects the waste discharge performance, an optimal toilet flush regarding the waste state can be performed

Note that, in the embodiment, the waste state is determined based on the numerical data of the pooled water level. However, instead of the numerical data of the pooled water level, the waste state may be determined based on the numerical date of the pressure of the pooled water, the captured image of the pooled water surface, or the like.

Note that, in S3, the type of waste may be determined from the captured image of the bowl 15 and the pooled water surface that are obtained by the camera 70, and the amount of waste may be determined from the numerical data of the pooled water level from the water level detection sensor 72. In this case, since the waste state is determined by combining the information regarding the waste obtained by the camera 70 and the water level detection sensor 72, the waste state with higher accuracy can be determined. Further, a line sensor camera may be used, and the waste state may be determined from information regarding the waste during falling of the waste. In this case, the waste state may be determined by appropriately combining the information regarding the waste that is obtained by the camera 70, the water level detection sensor 72, and the line sensor camera.

Furthermore, the controller 74 compares the pattern of the waste state determined based on the captured image of the bowl 15 and the pooled water surface obtained by the camera 70 with the pattern of the waste state determined based on the numerical data of the pooled water level from the water level detection sensor 72, and the controller 74 determines the current waste state when both of the patterns of the waste states match. Thus, since the waste state is determined by using the captured image of the bowl 15 and the pooled water surface and the numerical data of the pooled water level as the information regarding the waste, the waste state with high accuracy can be determined.

Next, the process proceeds to S4, and the controller 74 controls the electromagnetic opening and closing valve 40, the water supply channel switching valve 42, and the pressure pump 10 to start a flush to the toilet. First, the controller 74 opens the electromagnetic opening and closing valve 40 and fully opens the water supply channel switching valve 42 on the rim side. Flush water is thereby spouted from the rim spout port 20a and the bowl 15 is flushed (so-called “pre-rim spouting”)

Next, in S5, in a state of continuous spouting from the rim spout port 20a, the controller 74 drives the pressure pump 10 and the flush water is spouted from the jet spout port 24a (so-called “rim and jet spouting”). When the flush water is spouted from the jet spout port 24a, the discharge trap conduit 16 is filled with water, causing early siphon action. In S5, the controller 74 selects any one of the flush patterns A to D corresponding to the patterns A to D of the waste state determined in S3 described above, and controls the pressure pump 10 based on the selected flush pattern. Thus, the spout mode of flush water spouted from the jet spout port 24a is changed in accordance with the waste state.

The flush patterns A to D of the jet spouting executed in S5 will now be described in detail.

First, in the flush patterns A to D illustrated in FIGS. 6A to 6D, the time taken from the start to the end of jet spouting is substantially the same. Thus, since the time taken from the start to the end of jet spouting is substantially the same, the user from mistaking a change in the jet spouting duration that is a malfunction can be prevented.

The flush pattern A illustrated in FIG. 6A is executed when it is determined that the waste state corresponds to the pattern A of the waste state (type of waste: “solid waste”, amount of waste: “large”). The flush pattern A is set such that the pressure pump 10 is continually driven at 100% output from the start (time t1) to the end (time t2) of jet spouting in order to improve the waste discharge performance beyond that of a normal large flush. Specifically, while the pre-rim spouting is performed (time t0 to time t1), the pressure pump 10 is stopped. At time t1, a rotation speed of the pressure pump 10 increases to a maximum rotation speed (100% output), and the jet spouting is started. From time t1 to time t2, the pressure pump 10 is driven at a constant maximum rotation speed, and the jet spouting is performed at a high flow rate. At time t2, the rotation speed of the pressure pump 10 decreases, and the jet spouting ends. Subsequently, the flush water is spouted from the rim spout port 20a, and the pooled water W returns to the state before the start of flushing (so-called “post-rim spouting”). While the post-rim spouting is performed (time t2 to time t3), the pressure pump 10 is stopped. Thus, in the flush pattern A, the flow velocity of flush water spouted from the jet spout port 24a is made higher than that of a normal large flush. Further, in the flush pattern A, the controller 74 may drive the water supply channel switching valve 42 to supply the flush water to the water storage tank 8 during the jet spouting. The flush water amount of jet spouting while reducing the size of the water storage tank 8 can be increased, and the waste discharge performance can be improved.

The flush pattern B illustrated in FIG. 6B is executed when it is determined that the waste state corresponds to the pattern B of the waste state (type of waste: “mixed waste”, amount of waste: “standard”). The flush pattern B is a normal large flush, and is set such that the rotation speed of the pressure pump 10 is at 100% output after the start of jet spouting, and subsequently the pressure pump 10 is driven at 60% output (with respect to the maximum rotation speed). Specifically, while the pre-rim spouting is performed (time t0 to time t1), the pressure pump 10 is stopped. At time t1, the rotation speed of the pressure pump 10 increases to the maximum rotation speed (100% output), and jet spouting is started. From time t1 to time t2, the pressure pump 10 is driven at a constant maximum rotation speed, and jet spouting is performed at a high flow rate. At time t2, the rotation speed of the pressure pump decreases to a rotation speed of 60% output (with respect to the maximum rotation speed). From time t2 to time t3, the pressure pump 10 is driven at a constant rotation speed of 60% output, and jet spouting is performed at a medium flow rate. At time t3, the rotation speed of the pressure pump 10 decreases, and jet spouting ends. While the post-rim spouting is performed (time t3 to time t4), the pressure pump 10 is stopped. Thus, in the flush pattern B, a normal large flush is performed.

The flush pattern C illustrated in FIG. 6C is executed when it is determined that the waste state corresponds to the pattern C of the waste state (type of waste: “mixed waste”, amount of waste: “somewhat small”). The flush pattern C is set such that the pressure pump 10 is driven at 100% output after the start of jet spouting and is then temporarily stopped. Subsequently, the pressure pump 10 is driven again at 60% output (with respect to the maximum rotation speed). Specifically, while the pre-rim spouting is performed (time t0 to time t1), the pressure pump 10 is stopped. At time t1, the rotation speed of the pressure pump 10 increases to the maximum rotation speed (100% output), and the jet spouting is started. From time t1 to time t2, the pressure pump 10 is driven at a constant maximum rotation speed, and jet spouting is performed at a high flow rate. At time t2, the rotation speed of the pressure pump 10 decreases, and the jet spouting temporarily ends. From time t2 to time t3, the pressure pump 10 is stopped. At time t3, the rotation speed of the pressure pump 10 increases again to a rotation speed of 60% output, and jet spouting is performed again. From time t3 to time t4, the pressure pump 10 is driven at a constant rotation speed of 60% output, and jet spouting is performed at a medium flow rate. At time t4, the rotation speed of the pressure pump 10 decreases, and jet spouting ends. While the post-rim spouting is performed (time t4 to time t5), the pressure pump 10 is stopped. Thus, in the flushing pattern C, the time during which the flush water is spouted from the jet spout port 24a is shorter and the flow velocity of flush water spouted from the jet spout port 24a is lower than those of a normal large flush. Further, in the flush pattern C, the pressure pump 10 is stopped before the water level of the water storage tank 8 is lowered to the lowest water level L1 during normal use. The amount of flush water for jet spouting and save water can be reduced.

Further, the flush pattern D illustrated in FIG. 6D is executed when it is determined that the waste state corresponds to the pattern D of the waste state (type of waste: “floating waste”, amount of waste: “small”). The flush pattern D is set such that the pressure pump 10 is continually driven at 70% output (with respect to the maximum rotation speed) from the start (time t1) to the end (time t2) of the jet spouting. Specifically, while the pre-rim spouting is performed (time t0 to time t1), the pressure pump 10 is stopped. At time t1, the rotation speed of the pressure pump 10 increases to 70% output, and the jet spouting starts. From time t1 to time t2, the pressure pump 10 is driven at a constant rotation speed of 70% output, and jet spouting is performed at a medium flow rate. At time t2, the rotation speed of the pressure pump 10 decreases, and jet spouting ends. While the post-rim spouting is performed (time t2 to time t3), the pressure pump 10 is stopped. Thus, in the flush pattern D, the flow velocity of flush water spouted from the jet spout port 24a is made lower than that of a normal large flush. Further, in the flush pattern D, the pressure pump 10 is stopped before the water level of the water storage tank 8 is lowered to the lowest water level L1 during normal use. Therefore, the amount of flush water for jet spouting can be reduced and water can be saved.

As described above, in S5, jet spouting of any one of the flush patterns A to D described above is performed. Subsequently, the post-rim spouting is performed, and water is supplied to the water storage tank 8 by the controller 74 fully opening the water supply channel switching valve 42 on the tank side. When the water storage tank 8 is filled with water, the controller 74 closes the electromagnetic opening and closing valve 40, and the toilet flush ends (S6).

In the embodiment described above, in S5, the controller 74 changes only the spout mode of the flush water spouted from the jet spout port 24a, but may also change the spout mode of flush water spouted from the rim spout port 20a. In this case, the controller 74 controls the water supply channel switching valve 42 based on the determination of the waste state for each flush to the toilet to change the spout mode of the flush water spouted from the rim spout port 20a. Specifically, the controller 70 determines the waste state of the waste receiving surface 12 (waste adhesion state of dry surface) based on the captured image of the bowl 15 obtained by the camera 70, and changes the spout mode of the flush water spouted from the rim spout port 20a in accordance with this waste state.

Furthermore, in S5, the controller 74 may simultaneously change the spout modes of the flush water spouted from the jet spout port 24a and the rim spout port 20a. In this case, for each flush to the toilet, the controller 74 controls the pressure pump 10 based on the determination of the waste state so as to change the spout mode of the flush water spouted from the jet spout port 24a, and controls the water supply channel switching valves 42 based on the determination of the waste state so as to change the spout mode of flush water spouted from the rim spout port 20a. Specifically, the controller 74 determines the waste state of the waste receiving surface 12 (waste adhesion state of dry surface) based on the captured image of the bowl 15 obtained by the camera 70, and changes the spout mode of flush water spouted from the rim spout port 20a in accordance with this waste state. Further, the controller 74 determines the waste state based on the captured image of the pooled water surface obtained by the camera 70 and the numerical data of the pooled water level from the water level detection sensor 72, and changes the spout mode of flush water spouted from the jet spout port 24a. As a result, each spout mode can be changed according to the waste state of the corresponding area, and an optimal toilet flush can be performed according to the waste state.

Next, the actions and effects of the flush toilet 1 according to the embodiment of the present invention described above will be described.

First, in the flush toilet 1 according to the embodiment of the present invention, the controller 74 acquires an information regarding the waste for each flush to the toilet and controls the pressure pump 10 or the water supply channel switching valve 42 (flush water supply device) based on the determination of the waste state, thereby changing the spout mode of flush water spouted from the jet spout port 24a or the rim spout port 20a. Anan optimal toilet flush according to the waste state for each flush to the toilet can be performed, and further water saving can be achieved and waste discharge performance can be improved.

Further, in the flush toilet 1 according to the embodiment of the present invention, the flush water supply device is the pressure pump 10, and the controller 74 controls the pressure pump 10 so as to change the spout mode of flush water spouted from the jet spout port 24a. Therefore, the spout mode for each flush to the toilet can be easily changed.

In the flush toilet 1 according to the embodiment of the present invention, the controller 74 changes the flow velocity or the spouting duration of flush water spouted from the jet spout port 24a or the rim spout port 20a so as to change the spout mode of flush water spouted from the jet spout port 24a or the rim spout port 20a. Therefore, the spout mode can be easily changed. Further, in the flush toilet 1 according to the embodiment of the present invention, the controller 74 determines the waste state based on the information regarding the waste in the bowl 15 and in the pooled water W in the bowl 15. Therefore, based on the information regarding the waste in the bowl 15, which has a large impact on the toilet flushing performance, and based on the information regarding the waste in the pooled water, which has a large impact on the waste discharge performance, an optimal flush to the toilet according to the waste state can be performed.

In the flush toilet 1 according to the embodiment of the present invention, the controller 74 determines the waste state based on the type of waste and the amount of waste. Therefore, the waste state can be determined with high accuracy. Furthermore, in the flush toilet 1 according to the embodiment of the present invention, the controller 74 determines the waste state based on the position or the distribution of the waste. Therefore, the waste state can be determined with higher accuracy.

Further, in the flush toilet 1 according to the embodiment of the present invention, the controller 74 changes the spout mode of flush water spouted from the rim spout port 20a based on the waste state of the waste receiving surface 12 of the bowl 15 (waste adhesion state of dry surface), and changes the spout mode of flush water spouted from the jet spout port 24a based on the waste state of the pooled water in the bowl 15. Therefore, each spout mode in accordance with the waste state in the corresponding area can be changed, and an optimal toilet flush according to the waste state can be performed.

Next, another embodiment of the present invention will be described.

In the embodiment of the present invention described above, in the flush toilet, the flush water pressurized by the pressure pump 10 is spouted only from the jet spout port 24a, but may be spouted from both the jet spout port 24a and the rim spout port 20a. In this case, the downstream side of the pressure pump 10 is connected to the jet-side water supply channel 50 and the rim-side water supply channel 44.

In such an embodiment, since the controller 74 controls the pressure pump 10 in accordance with the waste state, the spout mode of flush water spouted from both the rim spout port 20a and the jet spout port 24a can be change.

Further, in the embodiment of the present invention described above, in the flush toilet, the pressure pump 10 is provided only in the jet-side water supply channel 50. However, a pressure pump different from the pressure pump 10 may be provided in the rim-side water supply channel 44, and flush water pressurized by each pressure pump may be spouted from each of the jet spout port 24a and the rim spout port 20a.

In such an embodiment, since the controller 74 controls the respective pressure pumps in accordance with the waste state, the spout mode of flush water spouted from the rim spout port 20a and the jet spout port 24a can be changed.

In the embodiment of the present invention described above, the flush toilet performs jet spouting, but may perform rim spouting only. In this case, the downstream side of the pressure pump 10 is connected to the rim-side water supply channel 44, and flush water pressurized by the pressure pump 10 is spouted from the rim spout port 20a.

In such an embodiment, since the controller 74 controls the pressure pump 10 in accordance with the waste state, the spout mode of flush water spouted from the rim spout port 20a can be changed.

Further, in the embodiment of the present invention described above, the flush toilet acquires information regarding waste excreted by the user as the information regarding waste, but may acquire information regarding toilet paper used by the user as the information regarding waste to determine the waste state.

In the embodiment of the present invention described above, the waste state is determined by acquiring the information regarding waste after the end of excretion. However, the waste state may be determined by acquiring the information regarding the waste during falling of the waste, using a line sensor camera or the like. Further, the waste state may be determined by combining information regarding waste after the end of excretion with information regarding waste during falling of the waste. Further, in the embodiment of the present invention described above, the flush water amount is changed depending on the waste state of waste present in the bowl and the pooled water surface, but may be changed depending on the waste state of the waste during falling of the waste.

Further, in the embodiment of the present invention described above, the flush patterns A to D corresponding to the patterns A to D of the waste state are set. However, for example, patterns of the waste state of the waste receiving surface of the bowl and patterns of the waste state in the pooled water may be separately set, and flush patterns corresponding to combinations of the patterns of each waste state may be set. Further, in the embodiment of the present invention described above, a flush to the toilet is performed with the flush patterns A to D corresponding to the patterns A to D of the waste state. However, the patterns are not limited to the patterns A to D, and the number of patterns can be decreased or increased in accordance with the flush toilet. Further, in the embodiment of the present invention described above, the patterns of the waste state and the flush patterns are stored in advance in the flush toilet, but may be stored in an external device of the flush toilet, and the flush toilet may be configured to wirelessly read the patterns from the external device.

The present invention is not limited to the embodiments described above, and various changes and modifications can be made within the scope of the technical idea described in the claims.

### Reference Signs List

1 Flush toilet
10 Pressure pump
12 Waste receiving surface
14 Rim
15 Bowl
16 Discharge trap conduit
20 Rim spouting portion
20a Rim spout port
24 Jet spouting portion
24a Jet spout port
40 Electromagnetic opening and closing valve
42 Water supply channel switching valve
68 Seating sensor
70 Camera
72 Water level detection sensor
74 Controller
76 Toilet flush switch
W Pooled water
X Solid waste
Y Floating waste

What is claimed is:

1. A flush toilet that flushes the toilet and discharges waste by using flush water, the flush toilet comprising:
a bowl including a waste receiving surface configured to receive the waste, and a rim formed above the waste receiving surface;
a discharge trap conduit connected to a lower part of the bowl to discharge the waste;
a spouting portion provided in the bowl to spout the flush water;
a flush water supply device configured to supply the flush water to the spouting portion;
a waste information acquisition device configured to acquire an information regarding the waste excreted in the bowl; and
a controller configured to determine a waste state by using the information regarding the waste and control the flush water supply device based on determination of the waste state;
wherein the controller controls the flush water supply device based on the determination of the waste state for each flush to the toilet so as to change a spout mode of the flush water spouted from the spouting portion.

2. The flush toilet according to claim 1, wherein the flush water supply device is a pump, and the controller controls the pump so as to change the spout mode of the flush water spouted from the spouting portion.

3. The flush toilet according to claim 2, wherein the controller changes a flow velocity or a spouting duration of the flush water spouted from the spouting portion so as to change the spout mode of the flush water spouted from the spouting portion.

4. The flush toilet according to claim 1, wherein the controller determines the waste state based on the information regarding the waste in the bowl and the waste in pooled water in the bowl.

5. The flush toilet according to claim 4, wherein the spouting portion includes a rim spouting portion provided in the rim to spout the flush water along the rim and a jet spouting portion provided at a bottom of the bowl to spout the flush water toward an inlet of the discharge trap conduit, and wherein the controller changes a spout mode of the flush water spouted from the rim spouting portion based on the waste state on the waste receiving surface of the bowl and changes the spout mode of the flush water spouted from the jet spouting portion based on the waste state in the pooled water in the bowl.

6. The flush toilet according to claim 1, wherein the controller determines the waste state based on a type of the waste and an amount of the waste, both of which are the information regarding the waste.

7. The flush toilet according to claim 6, wherein the controller determines the waste state based on a location or a distribution of the waste.
